(19) United States
(12) Patent Application Publication
(10) Pub. No.: US 2024/0180772 A1
(43) Pub. Date: Jun. 6, 2024

(54) INTELLIGENT MASSAGE CHAIR

(71) Applicant: Shanghai Rongtai Health Technology Corporation Limited, Shanghai (CN)

(72) Inventors: Qi LIN, Shanghai (CN); HANS Jorgen Dehli, San Clemente, CA (US); Guohui LI, Shanghai (CN); Guihui DENG, Shanghai (CN); Shangwen CHEN, Shanghai (CN); Feng ZHANG, Shanghai (CN)

(73) Assignee: Shanghai Rongtai Health Technology Corporation Limited, Shanghai (CN)

(21) Appl. No.: 18/279,212

(22) PCT Filed: May 31, 2021
(86) PCT No.: PCT/CN2021/097116

§ 371 Date: Aug. 29, 2023

(30) Foreign Application Priority Data
Apr. 26, 2021 (CN) 2021104528986
Apr. 26, 2021 (CN) 2021208767271

(51) Int. Cl. A61H 7/00; A47C 1/03

(52) U.S. Cl. CPC A61H 7/00; A47C 1/0308; A61H 2201/0149; A61H 2201/1215; A61H 2201/5058

(57) ABSTRACT

An intelligent massage chair is provided. The chair includes a chair frame and armrests connected on left and right sides of the chair frame. At least one of the armrests is connected to the chair frame through a flipping device. The flipping device includes a base connected to the chair frame and a flipping fixed seat rotatably connected to the base around a rotation axis extending left and right, the flipping fixed seat is fixed to the at least one of the armrests. When the flipping device flips the armrest to a set position, the chair frame has a side entrance on the side of the armrest. The armrest can be rotated open from the side to form a side entrance for users to sit in the massage chair from the left and right sides, which is convenient for users to sit in the massage chair.

### FIELD OF THE INVENTION

The present disclosure relates to the technical field of massage equipment, in particular, to an intelligent massage chair.

### BACKGROUND OF THE INVENTION

In recent years, with the accelerating pace of life, sub-health problems have become increasingly prominent and people's demand for massage has been increasing. Traditional massage is limited by venue, cost and personnel expertise, making it difficult for its popularity to develop rapidly. Intelligent massage chairs, on the other hand, can be used at home during fragmented time and at a low cost, and are increasingly being recognized by the public.

The existing intelligent massage chairs on the market usually have a three-sided wrap-around structure. That is, the intelligent massage chair includes a chair frame with a backrest and armrests installed on left and right sides of the chair frame. The backrest of the chair frame is set behind the user to support their body, and the armrests are set on left and right sides of the user to support their arms. The backrest and two armrests are usually quite high, so when using the massage chair, one needs to sit in from the front. However, existing intelligent massage chairs usually have a leg massage device in front, and the leg massage device is used to massage the user's calves. Therefore, for users with inconvenient legs and feet, there is a certain obstacle when sitting in from the front. To solve this problem, some solutions have emerged in this field in recent years.

For example, in a massage chair disclosed in a Japanese patent document with publication number JP2013-212349A, its leg massage device can be stored under the seat of the chair frame to avoid obstacles caused by the leg massage device when users sit in from the front. This makes it easier for users to sit in from the front. However, because the height and depth of the seat are limited by ergonomic values and also need to allow for storage of the leg massage device underneath the seat, this will greatly limit the size of the leg massage device which can only be made relatively small. However, with today's increasingly rich massage devices and functions, a small leg massage device can no longer meet the demand of users.

Further, in a massage chair disclosed in a Chinese patent document with publication number CN107693297A, its armrests are set to be able to open from the side of the chair frame. The chair frame includes a base (i.e., seat) and backrest. The rear end of the armrest is rotatably connected to the backrest and the front end of the armrest is connected to the base via an openable buckle. This allows for rotation of 0 to 90° around a vertically extending axis towards the outside of the armrests, thus facilitating the user to sit on the massage chair from the side. However, since the armrest is opened outwardly during this process, sufficient space must be reserved on outer sides of the massage chair, which is not conducive to placement of the massage chair in small venues. Additionally, after sitting on the massage chair from one side, users still need to turn sideways to pull the armrests back inward, which is inconvenient in use.

### SUMMARY OF THE INVENTION

The present disclosure provides an intelligent massage chair that is convenient for users to sit in and reduces the floor space occupied.

The intelligent massage chair includes a chair frame and armrests connected on left and right sides of the chair frame. At least one of the armrests is connected to the chair frame through a flipping device. The flipping device includes a base connected to the chair frame and a flipping fixed seat rotatably connected to the base around a rotation axis extending left and right, the flipping fixed seat is connected to the at least one of the armrests.

When the flipping device flips the armrest to a set position, the chair frame has a side entrance on the side of the armrest.

Further, the intelligent massage chair further includes a connecting rod connected between the chair frame and the flipping device. The chair frame includes a backrest frame and a seat frame rotatably connected with each other. The base is hinged to the backrest frame and an end of the connecting rod, and the other end of the connecting rod is hinged to the seat frame.

Further, the base includes a first shaft hole, through which the base is rotatable relative to the backrest frame. An angle is formed between a center axis of the first shaft hole and the rotation axis of the flipping fixed seat.

Further, a pulley is installed on the backrest frame, a chute is opened in the base, and the pulley is located in the chute. The pulley and the chute are guided and fit with each other.

Further, the flipping fixed seat is movably installed on the base around the rotation axis.

Further, the flipping device further includes a base shaft extending axially along the rotation axis, a rotating base sleeve threadedly connected to an outer periphery of the base shaft, a drive source connected to the base, and a transmission unit. The drive source is connected to the rotating base sleeve through the transmission unit and drives the rotating base sleeve to rotate. The base shaft is fixedly connected to the base, and the rotating base sleeve is fixedly connected to the flipping fixed seat.

Further, the flipping device further includes a flipping connecting sleeve sleeved on an outer periphery of the rotating base sleeve. An end of the flipping connecting sleeve is provided with a limiting flange part fixedly connected to the flipping fixed seat. The limiting flange part is located between the flipping fixed seat and the base shaft in an axial direction of the base shaft, and is capable of abutting against the base shaft. The other end of the flipping connecting sleeve is fixedly connected to the rotating base sleeve.

Further, the transmission unit includes a transmission worm rotatably supported in the base, and a turbine sleeve fixed on the outer periphery of the rotating base sleeve. A turbine portion is provided on the turbine sleeve and is in transmission engagement with the transmission worm, and the drive source is in transmission connection with the transmission worm, driving the transmission worm to rotate.

Further, an oil groove is opened on an inner peripheral surface of the rotating base sleeve.

Further, the intelligent massage chair further includes a controller and a current detector. The drive source is a motor, and the current detector is used to detect a current of the drive source. Both the current detector and the drive source are connected to the controller.

Further, a fixing groove is opened on the at least one of the armrests, and the flipping fixed seat is tightly fitted into the fixing groove.

Further, a positioning groove and a positioning column are respectively provided on the at least one of the armrests and the flipping fixed seat to fit with each other.

Further, a limiting boss is fixed on the at least one of the armrests, and a limiting groove is provided in the chair frame.

When the at least one of the armrests is not flipped and blocks the side entrance, the limiting boss is located in the limiting groove.

As described above, the intelligent massage chair of the present disclosure has the following beneficial effects:

In the present application, when the flipping fixed seat in the flipping device rotates around the rotation axis extending left and right, it drives the armrest fixedly connected to the flipping fixed seat to flip up and down. The armrest can be rotated open from the side to form a side entrance for users to sit in the massage chair from the left or right side. This is convenient for users to sit in the massage chair. Moreover, since the armrest is flipped open by rotating up and down, rather than flipping outwardly around a vertically extending axis as in existing technology, there is no need to reserve a large space on left and right sides of the massage chair during the process of forming a side entrance by flipping the armrest. This reduces the floor space occupied by the massage chair and facilitates its placement in small venues, ultimately greatly improving the convenience of using the massage chair.

### BRIEF DESCRIPTION OF DRAWINGS

FIGS. 1 to 4 show schematic diagrams of an intelligent massage chair in different states according to the present disclosure.

FIG. 5 shows an exploded view of an armrest of an intelligent massage chair according to the present disclosure.

FIG. 6 shows a schematic diagram of a chair frame connected with a flipping device according to the present disclosure.

FIG. 7 shows an enlarged view of circle A in FIG. 6.

FIGS. 8 and 9 show schematic diagrams of a flipping device from different perspectives according to the present disclosure.

FIGS. 10 and 12 show schematic diagrams of a flipping fixed seat in a flipping device at an initial position according to the present disclosure, with the base omitted.

FIGS. 11 and 13 show schematic diagrams of a flipping fixed seat in a flipping device at a flipped position according to the present disclosure, with the base omitted.

### REFERENCE NUMBERS

10 Chair frame
101 Backrest frame
102 Seat frame
103 Pulley
104 Limiting groove
20 Armrest
21 Fixing groove
22 Limiting boss
23 Flipping connection plate
30 Flipping device
31 Base
311 First shaft hole
312 Chute
313 Second shaft hole
32 Flipping fixed seat
321 Positioning column
33 Base shaft
34 Rotating base sleeve
341 Oil groove
342 Intermediate connecting flange
35 Drive source
36 Flipping connecting sleeve
361 Limiting flange part
362 Outer connecting flange
37 Transmission worm
38 Turbine sleeve
381 Turbine portion
382 Inner connecting flange
39 Worm shaft
310 Transmission turbine
40 Side entrance
50 Connecting rod
60 Leg massage device
70 Bearing

### DETAILED DESCRIPTION OF THE INVENTION

The embodiments of the present disclosure will be described below through exemplary embodiments. Those skilled in the art can easily understand other advantages and effects of the present disclosure according to contents disclosed by the specification.

It should be understood that the structures, proportions, sizes, and the like, which are illustrated in the drawings of the present specification, are used to clarify the contents disclosed in the specification for understanding and reading by those skilled, and are not intended to limit the implementation of the present disclosure, thus are not technically meaningful. Any modification of the structure, change of the scale, or adjustment of the size should still fall within the scope of the technical contents disclosed by the present disclosure without affecting the effects and achievable objectives of the present disclosure. In the meantime, the terms “upper”, “lower”, “left”, “right”, “intermediate” and “one” as used in this specification are also for convenience of description, and are not intended to limit the scope of the present disclosure, and the change or adjustment of the relative relationship is considered to be within the scope of the present disclosure without substantial changes in technology. It should be noted that in the following descriptions, the terms “upper”, “down”, “left”, “right”, “center/intermediate”, “front”, “back/rear”, “above”, “bottom”, “outer side”, “inner side” should be understood as directions seen from a user seated in the massage chair.

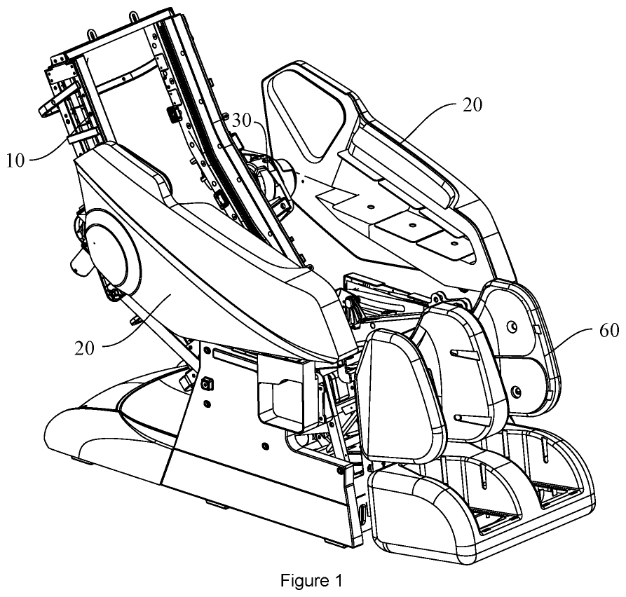

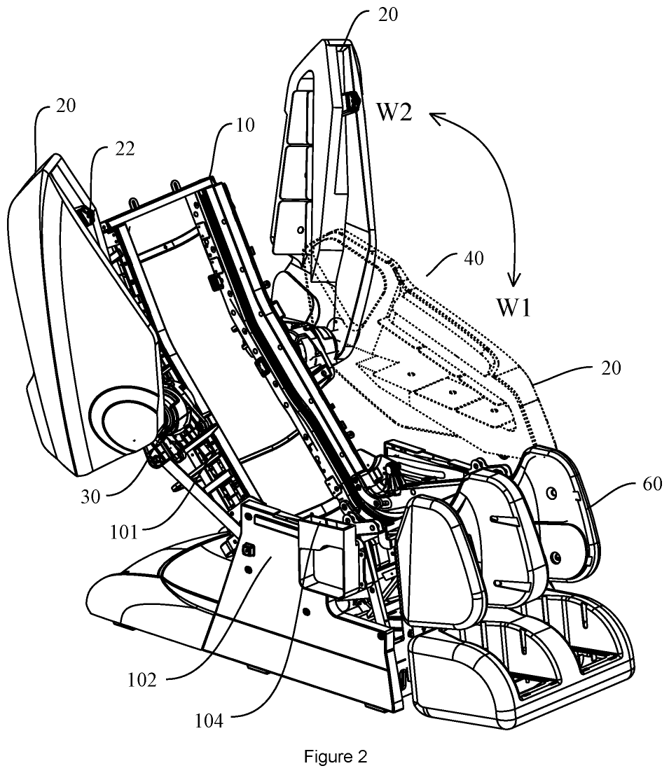

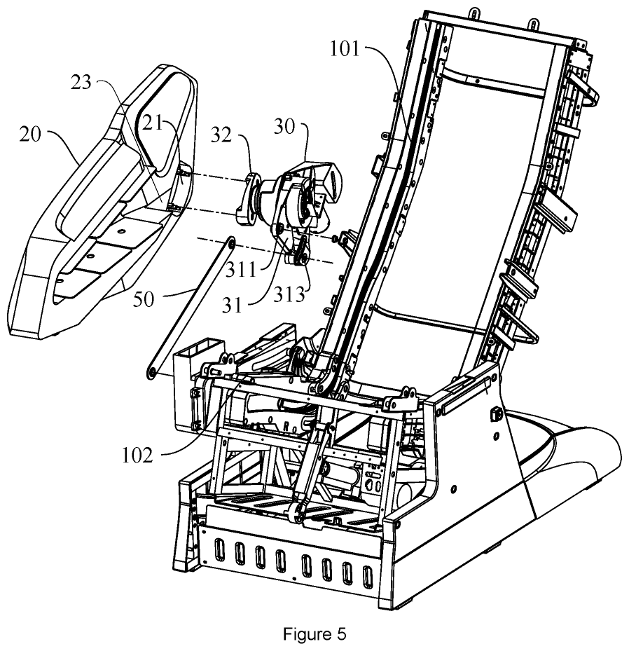

The present disclosure provides an intelligent massage chair, referred to as a massage chair for short. As shown in FIGS. 1 and 2, the massage chair includes a chair frame 10 and armrests 20 installed on left and right sides of the chair frame 10. Specifically, as shown in FIG. 5, at least one armrest 20 is rotatably connected to the chair frame 10 through a flipping device 30. In this way, it may be that the left armrest 20 is connected to the chair frame 10 through the flipping device 30, or the right armrest 20 is connected to the chair frame 10 through the flipping device 30, or both left and right armrests 20 are connected to the chair frame 10 through the flipping device 30. In this embodiment, both left and right armrests 20 are respectively connected to the chair frame 10 through a flipping device 30. The connection structure between the chair frame 10 and the left armrest 20 is symmetrical with respect to the connection structure between the chair frame 10 and the right armrest 20. The following describes a preferred connection structure between armrests 20 and the chair frame 10 with reference to the right armrest 20 of the massage chair.

As shown in FIG. 5, the flipping device 30 includes a base 31 disposed on the right side of the chair frame 10 and a flipping fixed seat 32 rotatably connected to the base 31 around a rotation axis extending left and right. The flipping fixed seat 32 is connected to the armrest 20. Therefore, when the flipping fixed seat 32 rotates around the rotation axis extending left and right (that is, the rotation axis extends along a horizontal line connecting the left side and the right side of the chair frame), the flipping fixed seat 32 drives the armrest 20 to rotate together, that is, the armrest 20 flips up and down. In this way, when the user needs to sit in the massage chair, the flipping fixed seat 32 in the flipping device 30 can be rotated to drive the armrest 20 to flip up to a set position or down to a set position. In the view shown in FIG. 2, the armrest 20 is flipped up from the normal massage position W1 to the set position W2, so that the armrest 20 is rotated open from the side and is in an open state. The right side of the chair frame 10 forms a side entrance 40 for users to sit in the massage chair from that side, which facilitates users to sit in the massage chair, especially for users with mobility difficulties. Moreover, since the armrest 20 is rotated open by flipping up and down instead of flipping outward around a vertically extending axis as in the prior art, it is not necessary to reserve a large space on both sides of the massage chair during the process of forming the side entrance 40 by flipping the armrest 20. This reduces the floor space occupied by the massage chair and facilitates placement of the massage chair in a small venue, ultimately greatly improving the convenience of using the massage chair. After sitting in the massage chair from the side of the massage chair, the flipping fixed seat 32 in the flipping device 30 rotates in a reverse direction and resets, driving the armrest 20 to also flip in the reverse direction and reset. Then the armrest 20 is in a closed state. After that, the massage chair can be used normally. This eliminates the need for users to manually buckle armrests after sitting in a massage chair as in prior art. It improves operability of the massage chair and improves convenience of using the massage chair from another aspect.

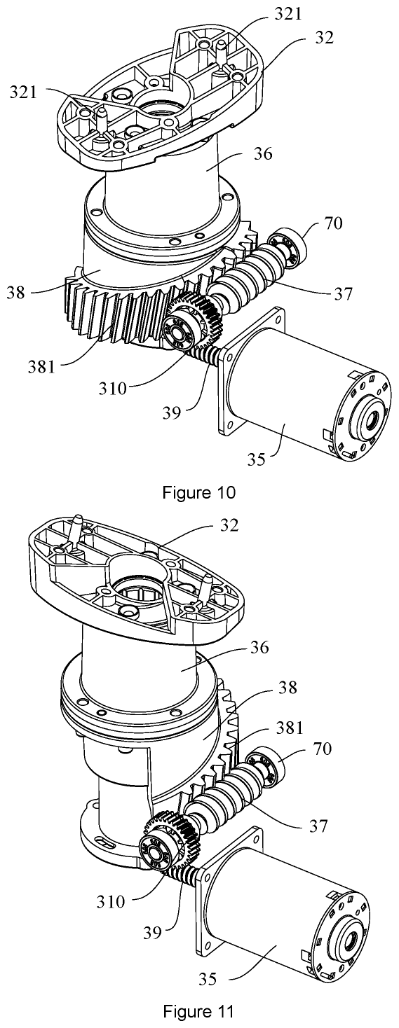

Further, a preferred connection way between the armrest 20 and the flipping fixed seat 32 is as follows. As shown in FIG. 5, a flipping connection plate 23 is provided on the inner side (i.e., left side) of the armrest 20 facing the chair frame 10. The flipping connection plate 23 includes a fixing groove 21. The contour shape of the fixing groove 21 matches the contour shape of the flipping fixed seat 32 and both are elliptical. The flipping fixed seat 32 is tightly fitted into the fixing groove 21 to realize connection between the flipping fixed seat 32 and the armrest 20. Preferably, a positioning groove and a positioning column 321 are respectively provided on the armrest 20 and the flipping fixed seat 32 to fit with each other. On one hand, it realizes positioning when the armrest 20 is fixedly connected with the flipping fixed seat 32; on other hand, it also improves reliability of fixed connection between the armrest 20 and the flipping fixed seat 32. Based on this, as shown in FIG. 5, a positioning column 321 is fixedly provided in the fixing groove 21 of the armrest 20; as shown in FIGS. 10 and 11, a positioning groove tightly matched with the positioning column 321 of the armrest 20 is provided on the outer side (i.e., right side) of the flipping fixed seat 32 facing the bottom of the fixing groove 21. Alternatively, as shown in FIGS. 10 and 11, a positioning column 321 is integrally provided on the outer side of the flipping fixed seat 32, and a positioning groove tightly matched with the positioning column 321 of the flipping fixed seat 32 is provided at the bottom of the fixing groove 21 on the armrest 20.

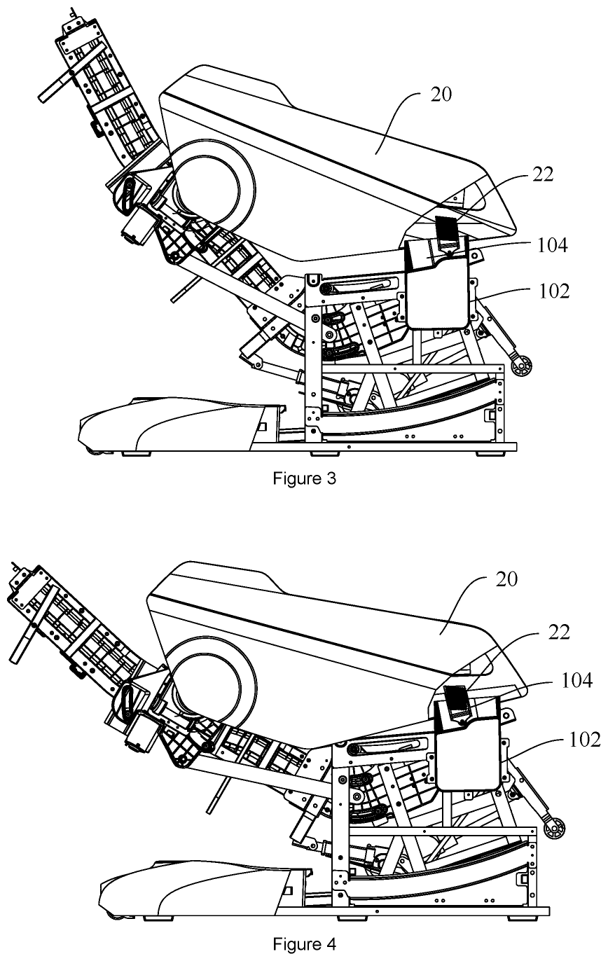

Further, as shown in FIGS. 1 and 2, the chair frame 10 includes a backrest frame 101 for supporting the user's back and a seat frame 102 for supporting the user's buttock and thighs. The backrest frame 101 and the seat frame 102 can be fixedly connected or rotatably connected through a rotating shaft. The massage chair further includes a leg massage device 60 for massaging the user's calves. The leg massage device 60 is arranged on the front side of the seat frame 102 and is rotatably connected to the seat frame 102 through a rotating shaft. Preferably, as shown in FIGS. 3 and 4, a limiting boss 22 is fixed to the bottom of the front portion of the armrest 20 (here the “bottom” and “front portion” refer to the positions of this armrest when the massage chair is in the W1 position), and a limiting groove 104 is provided in the seat frame 102 of the chair frame 10. When the user sits in the massage chair from the side entrance 40 on one side of the chair frame 10, the armrest 20 is flipping up and is in an open state. As shown in FIG. 3, the limiting boss 22 is detached from the limiting groove 104. When the user sits in the massage chair and uses the massage chair normally, the armrest 20 is not flipped up and is in a closed state. As shown in FIG. 4, the armrest 20 blocks the side entrance 40 and the limiting boss 22 is inserted into the limiting groove 104 to limit the left-right swing of the front end of the armrest 20 and increase the stability of the armrest 20 during normal use of the massage chair.

Further, in an example, the backrest frame 101 and the seat frame 102 of the chair frame 10 are rotatably connected with each other, which can make the backrest frame 101 of the chair frame 10 lie down and improve the comfort of using the massage chair. The rotation of the backrest frame 101 can be linked or not linked with the flipping of the armrest 20: when the two are not linked, when the backrest frame 101 lies down, the angle of the armrest 20 in the massage chair will not change, which means that the position of the user's arm relative to the seat frame 102 will not change, and at this time, the base 31 of the flipping device 30 is fixedly connected to the chair frame 10 by multiple screws; when the two are linked, when the backrest frame 101 lies down, the angle of the armrest 20 in the massage chair will change, which means that the position of the user's arm relative to the seat frame 102 will change, further improving the comfort of using the massage chair, and at this time, the intelligent massage chair further includes a connecting rod 50 connected between the backrest frame 101 of the chair frame 10 and the flipping device 30 to adjust the angle of the armrest 20 in the massage chair through the connecting rod 50.

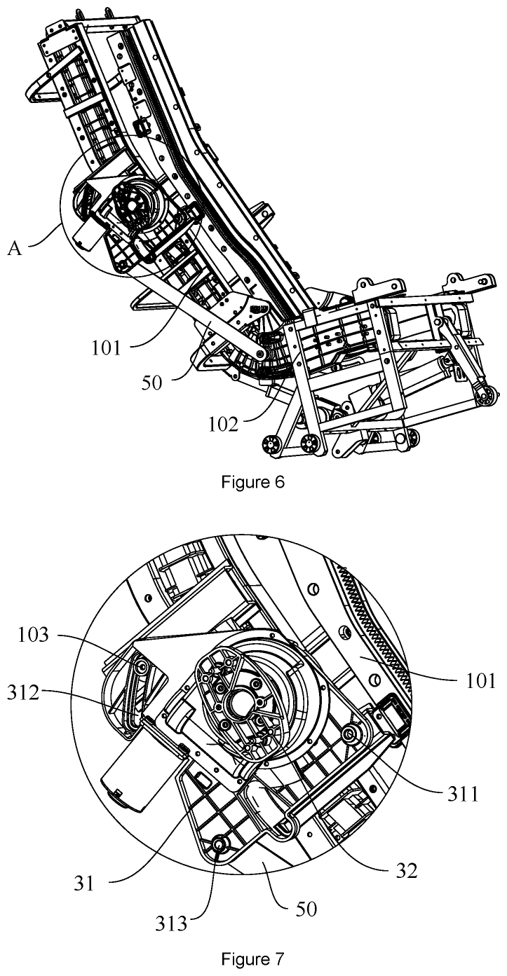

Specifically, as shown in FIGS. 5 to 7, the base 31 is hinged to the backrest frame 101 through a first pin shaft fixed on the backrest frame 101. The base 31 is hinged to the rear end of the connecting rod 50 through a second pin shaft fixed on the base 31. The front end of the connecting rod 50 is hinged to the seat frame 102 by a third pin shaft fixed on the seat frame 102. In this way, the base 31 and the backrest frame 101 have first shaft holes for rotation at the first pin shaft. The base 31 and the rear end of the connecting rod 50 have second shaft holes for rotation at the second pin shaft. The front end of the connecting rod 50 and the seat frame 102 have third shaft holes for rotation at the third pin shaft. The first pin shaft and the second pin shaft are staggered. When the angle between the backrest frame 101 and the seat frame 102 changes, the angle of the base 31 will change through the connecting rod 50, thereby changing the angle of the entire flipping device 30 relative to the backrest frame 101 and changing the angle of the armrest 20 fixed on the flipping device 30 relative to the backrest frame 101. In other words, the angle between the armrest 20 and the backrest frame 101 is adapted to the angle between the backrest frame 101 and the seat frame 102 to avoid significant changes in relative position between the armrest 20 and the backrest frame 101. For example, when the backrest frame 101 rotates backward relative to the seat frame 102, the user will lean backward; at the same time, the flipping device 30 drives the armrest 20 to move backward relative to the seat frame 102 together with the user's arm moving backward, thereby ensuring that the position of the user's arm does not change significantly and the use is more comfortable.

Preferably, a shaft sleeve is fixed in a first shaft hole 311 of the base 31, and the first pin shaft is rotatably passed through the shaft sleeve to ensure lubricity when the base 31 rotates relative to the first pin shaft. In addition, as shown in FIG. 7, a pulley 103 is installed on the backrest frame 101, and a chute 312 is opened in the base 31. The pulley 103 is located in the chute 312, and the two are guided and fit with each other. The guiding cooperation between the pulley 103 and the chute 312 can prevent the flipping device 30 from swaying at will when the angle changes, ensuring the stability of the overall mechanism in which the angle between the flipping device 30 and the armrest 20 changes when the angle between the backrest frame 101 and the seat frame 102 changes.

Further, the central axis of the first shaft hole 311 on the base 31 may or may not be parallel to the rotation axis of the flipping fixed seat 32. In this embodiment, the central axis of the first shaft hole 311 on the base 31 is not parallel to the rotation axis of the flipping fixed seat 32, that is, an angle is formed between the central axis of the first shaft hole 311 on the base 31 and the rotation axis of the flipping fixed seat 32. In this way, when the angle between the backrest frame 101 and seat frame 102 changes, the flipping device 30 drives the armrest 20 to change its position in a front-rear direction, and the flipping device 30 also drives the armrest 20 to flip at a certain angle relative to the side surface of chair frame 10, providing more freedom for space of the massage chair.

Further, in the flipping device 30, the flipping fixed seat 32 may only rotate around its rotation axis. At this time, the flipping fixed seat 32 may only drive the armrest 20 to turn up and down. Or, the flipping fixed seat 32 may move around its rotation axis while rotating. At this time, the flipping fixed seat 32 drives the armrest 20 to flip up and down while also driving the armrest 20 to move left and right; for example, when the flipping fixed seat 32 drives the armrest 20 to flip up and makes the armrest 20 in an open state, it also drives the armrest 20 to move away towards the outside of the chair frame 10. When the flipping fixed seat 32 drives the armrest 20 to flip down and makes the armrest 20 in a closed state, it also drives the armrest 20 to move towards the inside of the chair frame 10. In this embodiment, the flipping fixed seat 32 can be rotatably and movably mounted on the base 31 around its rotation axis. Based on this, preferred embodiments of the flipping device 30 are described below.

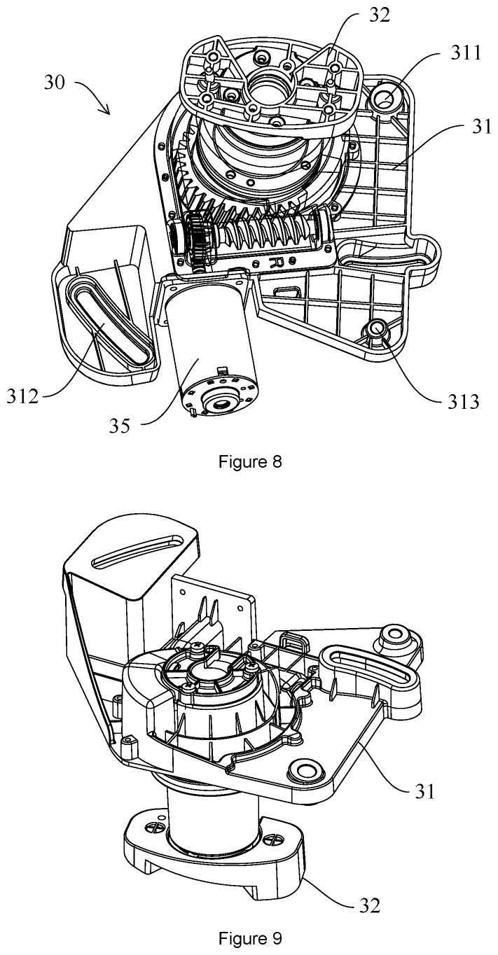

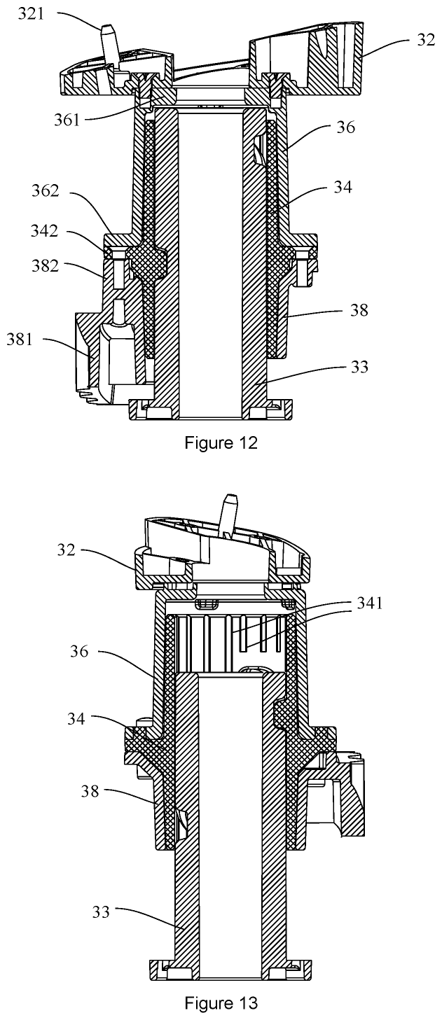

As shown in FIGS. 8 and 9, the flipping device 30 includes three main parts: the base 31, a flipping structure, and a driving structure. The base 31 is used to connect to the backrest frame 101 of the chair frame 10, thereby installing the flipping device 30 as a whole on the backrest frame 101 of the chair frame 10; both the flipping structure and the driving structure are installed on the base 31. The flipping fixed seat 32 is a component in the flipping structure. FIGS. 10 and 11 are schematic diagrams of the flipping structure and driving structure in the flipping device 30. FIG. 12 is a sectional view along the rotation axis of the flipping fixed seat 32 in FIG. 10. FIG. 13 is a sectional view along the rotation axis of the flipping fixed seat 32 in FIG. 11. Further, in FIGS. 10 and 12, the flipping fixed seat 32 is in its initial position and the armrest 20 is in an unflipped and closed state; in FIGS. 11 and 13, the flipping fixed seat 32 is in its flipped position and the armrest 20 is in a flipped and open state.

As shown in FIGS. 8 to 13, in addition to including the flipping fixed seat 32, the flipping structure of the flipping device 30 also includes a base shaft 33, a rotating base sleeve 34, a flipping connecting sleeve 36, and a turbine sleeve 38. The base shaft 33 extends axially along the rotation axis of the flipping fixed seat 32. The rotation axis of the flipping fixed seat 32 is also the central axis of the base shaft 33. The left end of the base 31 is fixedly connected to the base shaft 33 by several screws. Therefore, the left end of the base 31 has fixing holes as shown in FIG. 9. The rotating base sleeve 34 is threadedly connected to the outer periphery of the base shaft 33. Therefore, the outer peripheral surface of the base shaft 33 has threads and the inner peripheral surface of the rotating base sleeve 34 also has threads. The flipping connecting sleeve 36 is sleeved on the outer periphery of the right section of the base shaft 33, and the turbine sleeve 38 is sleeved on the outer periphery of the left section of the base shaft 33. The outer peripheral surface of the rotating base sleeve 34 is provided with an intermediate connecting flange 342. The left end of the flipping connecting sleeve 36 is provided with an outer connecting flange 362 located outside the intermediate connecting flange 342. The right end of the turbine sleeve 38 is provided with an inner connecting flange 382 located inside the intermediate connecting flange 342. The outer connecting flange 362, the intermediate connecting flange 342 and the inner connecting flange 382 are fixedly connected by several screws, thereby fixing and connecting three parts: the rotating base sleeve 34, the flipping connecting sleeve 36 and the turbine sleeve 38. The right end of the flipping connecting sleeve 36 integrally has a limiting flange part 361. The limiting flange part 361 is located between the flipping fixed seat 32 and the base shaft 33 in the axial direction of the base shaft 33. The limiting flange part 361 and the flipping fixed seat 32 are fixedly connected by several screws, thereby fixing and connecting the flipping connecting sleeve 36 and the flipping fixed seat 32. The driving structure is used to drive the turbine sleeve 38 to rotate.

When a user with inconvenient legs needs to sit in the massage chair from a side of the massage chair, the driving structure in the flipping device 30 acts to drive the turbine sleeve 38 to rotate. Then, the turbine sleeve 38 drives the rotating base sleeve 34, the flipping connecting sleeve 36 and the flipping fixed seat 32 to rotate together. While rotating relative to the base 31, the rotating base sleeve 34 also moves axially relative to the base shaft 33, thereby driving the flipping connecting sleeve 36 and the flipping fixed seat 32 to move left and right together. Therefore, while rotating, the flipping fixed seat 32 also moves in the left-right direction, driving the right armrest 20 to move right when flipping upwards to be open and move left when flipping downwards to be closed. After the armrest 20 moves left to reset, the limiting flange part 361 at the right end of the flipping connecting sleeve 36 abuts against the right end of base shaft 33 to play a limiting role during resetting. Preferably, as shown in FIG. 13, an oil groove 341 is opened on the inner peripheral surface of the rotating base sleeve 34. The oil groove 341 stores lubricating grease to ensure smooth movement of the rotating base sleeve 34.

Further, as shown in FIGS. 10 and 11, the driving structure of the flipping device 30 includes a drive source 35 connected to the base 31, a worm shaft 39 driven to rotate by the drive source 35, a transmission worm 37 rotatably supported at both ends by bearings 70 in the base 31, and a transmission turbine 310 fixed to the transmission worm 37 by an elastic pin. The worm shaft 39 is in transmission engagement with the transmission turbine 310. The turbine sleeve 38 is provided with a turbine portion 381 which extends helically and is in transmission engagement with the transmission worm 37. In this way, when the drive source 35 drives the worm shaft 39 to rotate, it drives the transmission worm 37 to rotate through the meshing of the worm shaft 39 and the transmission turbine 310, thereby driving the turbine sleeve 38 to rotate, and the turbine sleeve 38 drives the rotating base sleeve 34 to rotate together. Therefore, the worm shaft 39, the transmission turbine 310, the transmission worm 37 and the turbine sleeve 38 constitute a transmission unit connected between the drive source 35 and the rotating base sleeve 34. The drive source 35 is connected to the rotating base sleeve 34 through the transmission unit and drives the rotating base sleeve 34 to rotate. Preferably, the drive source 35 is a motor. The worm shaft 39 can be fixedly connected to the motor shaft of the motor through a coupling, or the worm shaft 39 can be an extension part of the motor shaft of the motor.

Further, the intelligent massage chair also includes a controller and a current detector. The current detector is used to detect the current of the drive source 35. Both the current detector and the drive source 35 are connected to the controller. The controller can control the rotation of the motor. Therefore, when a user sits in the massage chair, the controller can be used to drive the motor to rotate, causing the armrest 20 to flip up and open the side entrance 40, making it convenient for the user to enter the massage chair from the side entrance 40. Afterwards, the user uses the controller to drive the motor to rotate in reverse, causing the armrest 20 to flip down to its original position and close the side entrance 40, improving the intelligence of the massage chair. Specifically, the present application can detect the current of the motor through the current detector. When the current of the motor exceeds normal values, the controller controls the motor to stop urgently or move in the reverse direction to avoid interference from humans or machinery in the path of movement of the armrest 20, thereby preventing pinching or mechanical structure damage from occurring. The current detector may be a sensor.

In summary, the present disclosure effectively overcomes various disadvantages of the traditional technology and has high industrial application values.

The above-mentioned embodiments are just used for exemplarily describing the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

1. An intelligent massage chair, comprising a chair frame (10) and armrests (20) connected on left and right sides of the chair frame (10), wherein at least one of the armrests (20) is connected to the chair frame (10) through a flipping device (30), wherein the flipping device (30) comprises a base (31) connected to the chair frame (10) and a flipping fixed seat (32) rotatably connected to the base (31) around a rotation axis extending left and right, wherein the flipping fixed seat (32) is connected to the at least one of the armrests (20); wherein when the flipping device (30) flips the at least one of the armrests (20) to a set position, the chair frame (10) has a side entrance (40) on the side of the at least one of the armrests (20).

2. The intelligent massage chair according to claim 1, further comprising a connecting rod (50) connected between the chair frame (10) and the flipping device (30), wherein the chair frame (10) comprises a backrest frame (101) and a seat frame (102) rotatably connected with each other, wherein the base (31) is hinged to the backrest frame (101) and an end of the connecting rod (50), and the other end of the connecting rod (50) is hinged to the seat frame (102).

3. The intelligent massage chair according to claim 2, wherein the base (31) includes a first shaft hole (311), through which the base (31) is rotatable relative to the backrest frame (101), wherein an angle is formed between a center axis of the first shaft hole (311) and the rotation axis of the flipping fixed seat (32).

4. The intelligent massage chair according to claim 2, wherein a pulley (103) is installed on the backrest frame (101), a chute (312) is opened in the base (31), and the pulley (103) is located in the chute (312), wherein the pulley (103) and the chute (312) are guided and fit with each other.

5. The intelligent massage chair according to claim 1, wherein the flipping fixed seat (32) is movably installed on the base (31) around the rotation axis.

6. The intelligent massage chair according to claim 5, wherein the flipping device (30) further comprises a base shaft (33) extending axially along the rotation axis, a rotating base sleeve (34) threadedly connected to an outer periphery of the base shaft (33), a drive source (35) connected to the base (31), and a transmission unit, wherein the drive source (35) is connected to the rotating base sleeve (34) through the transmission unit and drives the rotating base sleeve (34) to rotate, wherein the base shaft (33) is fixedly connected to the base (31), and the rotating base sleeve (34) is fixedly connected to the flipping fixed seat (32).

7. The intelligent massage chair according to claim 6, wherein the flipping device (30) further comprises a flipping connecting sleeve (36) sleeved on an outer periphery of the rotating base sleeve (34), wherein an end of the flipping connecting sleeve (36) is provided with a limiting flange part (361) fixedly connected to the flipping fixed seat (32), wherein the limiting flange part (361) is located between the flipping fixed seat (32) and the base shaft (33) in an axial direction of the base shaft (33), and is capable of abutting against the base shaft (33), wherein the other end of the flipping connecting sleeve (36) is fixedly connected to the rotating base sleeve (34).

8. The intelligent massage chair according to claim 6, wherein the transmission unit comprises a transmission worm (37) rotatably supported in the base (31), and a turbine sleeve (38) fixed on the outer periphery of the rotating base sleeve (34), wherein a turbine portion (381) is provided on the turbine sleeve (38) and is in transmission engagement with the transmission worm (37), and the drive source (35) is in transmission connection with the transmission worm (37), driving the transmission worm (37) to rotate.

9. The intelligent massage chair according to claim 6, wherein an oil groove (341) is opened on an inner peripheral surface of the rotating base sleeve (34).

10. The intelligent massage chair according to claim 6, further comprising a controller and a current detector, wherein the drive source (35) is a motor, and the current detector is used to detect a current of the drive source (35), wherein both the current detector and the drive source (35) are connected to the controller.

11. The intelligent massage chair according to claim 1, wherein a fixing groove (21) is opened on the at least one of the armrests (20), and the flipping fixed seat (32) is tightly fitted into the fixing groove (21).

12. The intelligent massage chair according to claim 1, wherein a positioning groove and a positioning column (321) are respectively provided on the at least one of the armrests (20) and the flipping fixed seat (32) to fit with each other.

13. The intelligent massage chair according to claim 1, wherein a limiting boss (22) is fixed on the at least one of the armrests (20), and a limiting groove (104) is provided in the chair frame (10);
wherein when the at least one of the armrests (20) is not flipped and blocks the side entrance (40), the limiting boss (22) is located in the limiting groove (104).

14. The intelligent massage chair according to claim 2, wherein the flipping fixed seat (32) is movably installed on the base (31) around the rotation axis.
